(19) United States
(12) Patent Application Publication
(10) Pub. No.: US 2005/0099272 A1
(43) Pub. Date: May 12, 2005

(54) Method for automobile security and evidence provision using photography

(76) Inventors: Jung-Huang Kuo, Tungshih Chen (TW); Hung-Wei Chiang, Taiping City (TW)

Correspondence Address: Jung-Huang Kuo & Hung-Wei Chiang, P.O. Box No. 6-57, Junghe, Taipei, 235, TW

(21) Appl. No.: 10/704,580

(22) Filed: Nov. 12, 2003

(51) Int. Cl. B60R 25/10

(52) U.S. Cl. 340/426.1; 340/539.17; 348/148

(57) ABSTRACT

A method for automobile security and evidence provision using photography is accomplished by photography equipment. The photography equipment is capable of capturing dynamic images in and out of the automobile. The image contents captured are processed into digital signals further sent to a control center using wireless transmission. The control center monitors, processes, stores or feeds back the received signals, thereby accomplishing security evidence provision purposes.

### BACKGROUND OF THE INVENTION

(a) Field of the Invention

The invention relates to a method for automobile security and evidence provision using photography, and more particularly, to a method wherein images captured by photography equipment installed in an automobile are transmitted to a control center for further monitoring, storage and feedback, thereby providing automobile security and evidence provision effects.

(b) Description of the Prior Art

Living standards of modern days are gradually elevated. While enjoying conveniences in life, transportation means utilized by people is also replaced by automobiles from prior bicycles and motorcycles. Popularity of automobiles has resultantly surged, and scenes of automobiles running in either small lanes or large boulevards are only more than common in people's every life. However, accompanied with expanding amount of automobiles, automobile accidents are inevitably and relatively increased. Occurrences such as minor collisions, over-speeding disturbances, accidents caused by driving drunk, automobile thefts and malevolent automobile destructions repeatedly take place. Even worse, there are major criminal cases including kidnapping and robbery associated with automobiles, and these criminal behaviors become threats to life and property of automobile proprietors. To the present day, automobile proprietors are not provided with any measures for collecting evidence, security proof or precautions, and therefore opportunities for solving criminal cases are often missed for not being able to report the cases in fastest times when the above occurrences happen. In addition, after the above occurrences have taken place, indemnification or self-protection is also made difficult with insufficient evidence. Therefore, one often feels helpless when encountering the aforesaid occurrences.

### SUMMARY OF THE INVENTION

An object of the invention is to provide a method for fulfilling requirements of automobile security and evidence provision purposes, wherein image and sound signals in an out of an automobile are captured and transmitted to a control center, and the control center then monitors, stores or feeds back the image and sound signals received.

According to the invention, a method for automobile security and evidence provision using photography comprises steps of:
a) installing photography equipment: a single set of multiple sets of photography equipment is installed in an automobile;
b) capturing image data: various dynamic image data in and out of the automobile are captured by the aforesaid photography equipment;
c) performing wireless transmission: the image data captured are processed into digital signals further transmitted by wireless transmission;
d) receiving the digital signals by a control center: a control center receives the digital signals transmitted; and
e) responding to the digital signals: the control center responds to the digital signals.

Wherein, this step is carried out as the following procedures:
e1) storing the digital signals: the digital signals are stored; or/and
e2) feeding back: the digital signals are processed and fed back to the automobile; and/or
e3) notifying the automobile proprietor: alarming signals are sent to the automobile proprietor in cases of abnormal situations.

### BRIEF DESCRIPTION OF THE DRAWINGS

FIG. 1 shows a flow chart illustrating the method according to the invention.

### DETAILED DESCRIPTION OF THE PREFERRED EMBODIMENTS

To better understand the invention, detailed descriptions shall be given with the accompanying drawing below.

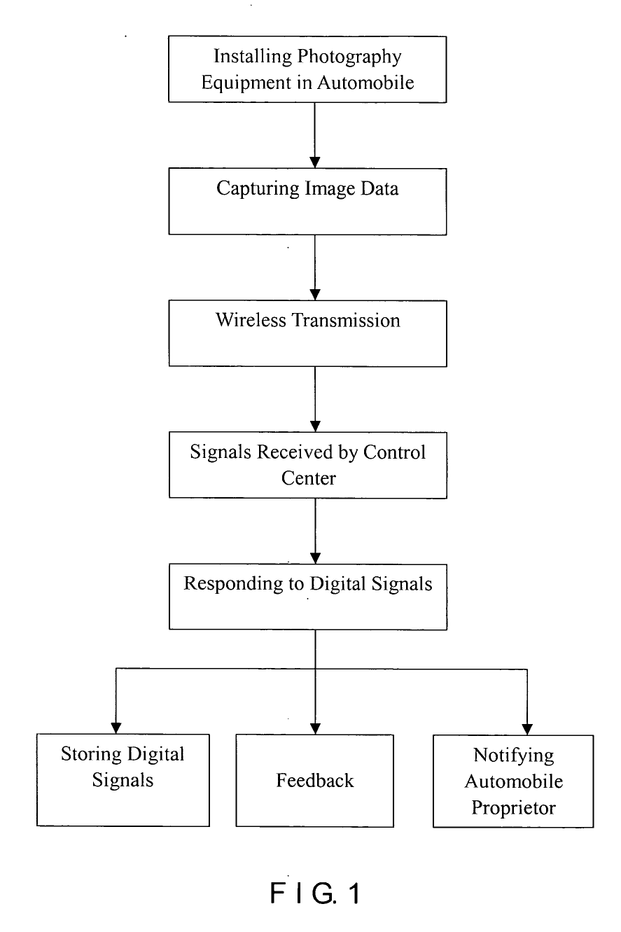

Referring to FIG. 1, the invention comprises steps of:
a) installing photography equipment: a single set of multiple sets of photography equipment is installed in an automobile, and structures and related installation techniques of the photography equipment are prior arts that shall not be redundantly described;
b) capturing image data: various image and sound data in and out of the automobile are captured and taken by the aforesaid photography equipment;
c) performing wireless transmission: the image data captured are processed into digital signals further transmitted by wireless transmission, and the digital signals are compressed when necessary;
d) receiving the signals by a control center: a control center receives the digital signals transmitted in the previous step; and
e) responding to the digital signals: the control center responds to the digital signals; wherein, this step is carried out as the following procedures:
   e1) storing the digital signals: the digital signals are stored; or/and
   e2) feeding back: the digital signals are processed and fed back to the automobile; and/or
   e3) notifying automobile proprietor: alarming signals are sent to the automobile proprietor in the presence of abnormal situations.

The invention is suitable in the occasions below:
1. During traveling of an automobile, dynamic images in and out of the automobile are captured and taken by the photography equipment. The images captured are continuously processed into digital signals that are further transmitted to the control center. The control center compares and processes the information acquired and feeds the processed information back to the automobile. The information fed back may serve as route indication, or may be stored for evidence when needed.
2. In case of accidents occurred during traveling of the automobile, the control center proceeds with follow-up actions such as reporting the case and providing accident evidence according to the digital signals received. The digital signals are stored at the control center, and therefore evidence provision of the automobile accident is ensured for assisting clarification of accident responsibilities.
3. During traveling of the automobile, in case the automobile proprietor experiences discomforts or encounters criminals invasions, the control center immediately reports the case to the police upon reception of the digital signals, thereby maintaining life and property securities of the automobile proprietor.
4. When the automobile is away from the automobile, in case of automobile theft, theft of belongings inside the automobile or intentional car destruction, the control center is able to immediately get hold of current situations of the automobile according to the digital signals received, and to further report to the police and also to send alarming signals to the automobile proprietor. The automobile proprietor may then take appropriate actions, and assist in catching the responsible criminal according to contents of images captured.
5. During traveling of the automobile, in case of coming across unexpected situations, evidence can be taken in conjunction with photography. Or, live broadcast may be performed via the control center, so as to grasp precious first-hand information at all times. Conclusive from the above descriptions, the invention has the following excellences:
1. The invention is capable of being in good command of unexpected situations in and out of an automobile, and subsequent action can be thus carried out as appropriate. Lift and property securities of the automobile proprietor are ensured, thereby accomplishing purposes of preventing thefts, robberies and destructions.
2. Archived images according to the invention can be recognized as basis of effective evidence for security proof as well as auxiliary information in accident determination.
3. The invention also serves as mobile photography equipment, and images of surrounding people and objects can be captured at all times, thereby facilitating on-site or future information inquiry and collection.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A method for automobile security and evidence provision using photography comprising steps of:
a) installing photography equipment: photography equipment is installed in an automobile;
b) capturing image data: dynamic images in and out of the automobile are captured by the photography equipment;
c) performing wireless transmission: the images captured are processed into digital signals further transmitted by wireless transmission;
d) receiving the signals by a control center: a control center receives the digital signals transmitted in the previous step, and monitors and deciphers the digital signals; and
e) responding to the digital signals.

2. The method for automobile security and evidence provision using photography in accordance with claim 1, wherein a response to the digital signals is to store the digital signals.

3. The method for automobile security and evidence provision using photography in accordance with claim 1, wherein a response to the digital signals is to feed back the signals; that is, information processed is fed back to the automobile.

4. The method for automobile security and evidence provision using photography in accordance with claim 1, wherein a response to the digital signals is to send a notification to a proprietor of the automobile.
